(19) United States
(12) Patent Application Publication
(10) Pub. No.: US 2015/0258968 A1
(43) Pub. Date: Sep. 17, 2015

(54) VEHICLE WIPER DEVICE

(71) Applicant: ASMO CO., LTD., Shizuoka (JP)

(72) Inventor: Takashi Umeno, Kosai-city (JP)

(73) Assignee: ASMO CO., LTD., Kosai-city, Shizuoka-pref. (JP)

(21) Appl. No.: 14/432,482

(22) PCT Filed: Oct. 17, 2013
(86) PCT No.: PCT/JP2013/078234

§ 371 Date: Mar. 31, 2015

(30) Foreign Application Priority Data
Oct. 18, 2012 (JP) 2012-231132

(51) Int. Cl. B60S 1/52; B60S 1/34; B60S 1/04

(52) U.S. Cl. CPC B60S 1/524; B60S 1/0491; B60S 1/3415

(57) ABSTRACT

A vehicle wiper device including: a wiper blade that wipes a specific range between a lower return position and an upper return position on a wiping target face; a wiper arm that has a leading end side coupled to a length direction center portion of the wiper blade and that swings to-and-fro about a base end side of the wiper arm to cause the wiper blade to swing to-and-fro, wherein at least a portion of the wiper arm that locates further to the base end side than a portion of the wiper arm coupled to the wiper blade is disposed at the upper return position side with respect to the wiper blade; and a first washer nozzle that is provided to the wiper arm disposed further to the upper return position side than the wiper blade and that squirts a cleaning fluid on the upper return position side of the wiper blade.

### TECHNICAL FIELD

The present invention relates to a vehicle wiper device for wiping a target face, and relates in particular to a vehicle wiper device provided with a washer nozzle in order to squirt a cleaning fluid onto the target face.

### BACKGROUND ART

In a vehicle wiper device described in Japanese Patent Application Laid-Open (JP-A) No. 2006-347302, in a state in which a wiper blade is positioned in a lower return position (referred to as a stationary position in the Laid-Open Application), a wiper arm is disposed further to the vehicle front side (and also to the lower return position side) than the wiper blade, and a washer nozzle attached to the wiper arm crosses above the wiper blade and projects out toward an upper return position (referred to as a return position in the Laid-Open Application) side.

As a result, washer fluid can be supplied onto the surface of a windshield glass at a front side in a swing direction of the wiper blade from an extremely close distance to the wiper blade, even when the wiper blade is in the lower return position.

### SUMMARY OF INVENTION

### Technical Problem

However, since in the above configuration the wiper arm is disposed further to the vehicle front side than the wiper blade in the state in which the wiper blade is positioned in the lower return position, airflow passing between the wiper arm and the windshield glass while the vehicle is traveling is obstructed by the wiper blade, and flows above the wiper blade. As a result, the airflow crosses the ejection trajectory of washer fluid that has been ejected toward the surface of the windshield glass from the washer nozzle, which is provided at the wiper arm and crosses above the wiper blade so as to project out toward the upper return position side. As a result, the washer fluid is heavily affected by the airflow, for example being blown upward.

As described in JP-A No. 2008-137459, in order to prevent airflow from crossing the ejection trajectory of washer fluid toward a windshield glass surface, configuration is made in which washer fluid is ejected from a washer nozzle provided at coupling locations of a wiper blade and a wiper arm. The washer fluid is ejected toward both ends in a length direction of the wiper blade and on the upper return position side of the wiper blade.

However, in the configuration of JP-A No. 2008-137459, airflow flows along the length direction of the wiper blade at a partway position while the wiper blade is wiping toward the upper return position, such that there is a possibility that ejection of washer fluid toward the length direction base end side of the wiper blade is pressed back by the airflow, and sufficient washer fluid does not travel across to the base end side of the wiper blade.

In consideration of the above circumstances, a subject of the present invention is to obtain a wiper device capable of squirting a cleaning fluid while suppressing to a minimum the effect of airflow while a vehicle is traveling. Solution to Subject

A vehicle wiper device according to a first aspect of the present invention includes: a wiper blade that wipes a specific range between a lower return position and an upper return position on a wiping target face, by swinging to-and-fro between the lower return position and the upper return position on the wiping target face; a wiper arm that has a leading end side coupled to a center portion in a length direction of the wiper blade and that swings to-and-fro about a base end side of the wiper arm to cause the wiper blade to swing to-and-fro between the lower return position and the upper return position, wherein at least a portion of the wiper arm that locates further to the base end side than a portion of the wiper arm coupled to the wiper blade is disposed at an upper return position side with respect to the wiper blade; and a first washer nozzle that is provided at the portion of the wiper arm disposed further to the upper return position side than the wiper blade, and that squirts a cleaning fluid toward the upper return position side of the wiper blade.

In the vehicle wiper device of the first aspect of the present invention, when the wiper arm swings to-and-fro about the base end side thereof, the wiper blade coupled to the leading end side of the wiper arm swings to-and-fro between the lower return position and the upper return position on the wiping target face. The wiper blade thereby wipes over a specific range between the lower return position and the upper return position on the wiping target face.

The wiper arm is coupled to the center portion in the length direction of the wiper blade, and at least a portion of the wiper arm that locates further to the base end side than the coupling portion of the wiper arm is disposed at the upper return position side with respect to the wiper blade. The first washer nozzle is provided at the portion of the wiper arm disposed further to the upper return position side with respect to the wiper blade. Namely, the first washer nozzle provided at the wiper arm is disposed at the upper return position side of the wiper blade without crossing the wiper blade, and disposed further to the base end side in the length direction of the wiper blade than the coupling portion of the wiper arm to the wiper blade.

Thus when supplying cleaning fluid to the first washer nozzle, the cleaning fluid is supplied to the wiping target face at the base end side in the length direction of the wiper blade and on the upper return position side of the wiper blade.

Airflow, which is flowing on the wiping target face from the front toward the rear of the vehicle while the vehicle is travelling, is thereby prevented from crossing the ejection trajectory of the cleaning fluid from the first washer nozzle toward the wiping target face, and the cleaning fluid is less liable to be affected by the airflow. Moreover, even when the airflow is flowing along the length direction of the wiper blade while the wiper blade is at a partway position wiping toward the upper return position, since the washer nozzle is provided further to the base end side than the coupling location of the wiper arm to the wiper blade, the effect of the airflow can be kept to a minimum due to there being an extremely close distance from the washer nozzle to the length direction base end side of the wiper blade, and the washer fluid can be sufficiently supplied toward the wiping target face.

A vehicle wiper device according to a second aspect of the present invention is the first aspect of the present invention, further including an airflow passage suppression portion that is provided at at least a portion of the wiper blade, the portion of the wiper blade locates further to the base end side than a coupling portion of the wiper blade to the wiper arm. The airflow passage suppression portion suppresses or restricts airflow from passing between the first washer nozzle and the wiping target face while the vehicle is travelling.

In the vehicle wiper device of the second aspect of the present invention, the airflow passage suppression portion is provided at at least a portion of the wiper blade, the portion of the wiper blade locates further to the base end side than the coupling portion of the wiper blade to the wiper arm, and the airflow flowing on the wiping target face while the vehicle is travelling is effectively suppressed or restricted from passing between the first washer nozzle and the wiping target face by the airflow passage suppression portion.

This enables the airflow, that flows on the wiping target face from the front toward the rear of the vehicle while the vehicle is travelling, to be further prevented from crossing the ejection trajectory of the cleaning fluid from the first washer nozzle toward the wiping target face.

A vehicle wiper device according to a third aspect of the present invention is the second aspect of the present invention, wherein the airflow passage suppression portion is provided at an upper portion of the wiper blade, and the airflow passage suppression portion is configured to guide the airflow to the opposite side to the wiping target face with respect to the first washer nozzle, and to press the wiper blade against the wiping target face.

In the vehicle wiper device of the third aspect of the present invention, the airflow blown onto the wiper blade is guided above the opposite side to the wiping target face with respect to the first washer nozzle by the airflow passage suppression portion that is provided to the upper portion of the wiper blade.

The airflow therefore passes the wiper blade at the opposite side to the wiping target face, thereby enabling passage of the airflow between the first washer nozzle and the wiping target face to be prevented or reduced. Moreover, the wiper blade is pressed against the wiping target face by guiding the airflow above the opposite side to the wiping target face by the airflow passage suppression portion provided to the upper portion of the wiper blade. This also enables the wiper blade to be prevented from lifting up off the wiping target face.

A vehicle wiper device according to a fourth aspect of the present invention is any one of the first aspect to the third aspect of the present invention, wherein the first washer nozzle acts as a base end side nozzle supplying the cleaning fluid further to the base end side than the coupling portion of the wiper blade, and a second washer nozzle is provided further to the leading end side of the wiper arm than the first washer nozzle, with the second washer nozzle acting as a leading end side nozzle supplying the cleaning fluid on the upper return position side of the wiper blade and further to the leading end side than the coupling portion of the wiper blade.

In the vehicle wiper device of the fourth aspect of the present invention, the first washer nozzle acts as a base end side nozzle supplying the cleaning fluid further to the base end side than the coupling portion of the wiper blade to the wiper arm, and the second washer nozzle acts as a leading end side nozzle provided further to the leading end side of the wiper arm than the first washer nozzle acting as a base end side nozzle. The leading end side nozzle supplies the cleaning fluid on the upper return position side of the wiper blade and further to the length direction leading end side than the coupling portion.

In cases in which the wiping target face is wiped by a long wiper blade, when cleaning fluid is supplied from the first washer nozzle acting as a base end side nozzle, the airflow can be used to some extent to supply the cleaning fluid toward the leading end portion of the wiper blade; however it takes time for the cleaning fluid to spread across to the leading end portion. However, since the second washer nozzle acting as a leading end side nozzle is provided further to the leading end side of the wiper arm than the first washer nozzle, a sufficient amount of liquid can be quickly spread across to the leading end portion, even in cases in which a long wiper blade is used.

A vehicle wiper device according to a fifth aspect of the present invention is the fourth aspect of the present invention, wherein the wiper arm includes a pair of side walls, and the first washer nozzle is disposed at the side wall at the wiper blade side from out of the pair of side walls, and the second washer nozzle is disposed at the side wall at the opposite side to the wiper blade side from out of the pair of side walls.

In the vehicle wiper device of the fifth aspect of the present invention, the wiper arm includes the pair of side walls, and the first washer nozzle is disposed at the side wall at the wiper blade side from out of the pair of side walls, and the second washer nozzle is disposed at the side wall at the opposite side to the wiper blade side from out of the pair of side walls.

The wiper arm is disposed alongside the wiper blade at a location further to the base end side than the coupling position of the wiper arm to the wiper blade, such that supply of the cleaning fluid to the base end side of the wiper blade is mainly performed through the first washer nozzle provided at the wiper arm. Of the pair of side walls of the wiper arm, it is preferable that the first washer nozzle is disposed at the side wall at the wiper blade side, to enable unimpeded supply toward the wiper blade at contact locations with the wiping target face, while also being less liable to be affected by airflow.

The cleaning fluid is supplied to the leading end side of the wiper blade by being ejected from the second washer nozzle provided at the wiper arm toward the length direction leading end side of the wiper blade. Providing the second washer nozzle at the side wall at the opposite side to the wiper blade side of the pair of side walls of the wiper arm enables ejection toward the length direction leading end side of the wiper blade without crossing the wiper arm.

A vehicle wiper device according to a sixth aspect of the present invention is the second aspect or the third aspect of the present invention, wherein a face of the airflow passage suppression portion, at the opposite side from the wiper blade, has an inclined face with an increasing thickness in cross-section of the airflow passage suppression portion on progression from the lower return position side toward the upper return position side.

In the vehicle wiper device of the sixth aspect of the present invention, the face of the airflow passage suppression portion at the opposite side from the wiper blade has an inclined face due to an increasing cross-section thickness of the airflow passage suppression portion on progression from the lower return position side toward the upper return position side, such that the airflow blown onto the wiper blade can be guided above the opposite side to the wiping target face of the first washer nozzle by the inclined face. Namely, the airflow can be prevented or reduced from passing between the first washer nozzle and the wiping target face. Advantageous Effects of Invention

The wiper device of the present invention enables a cleaning fluid to be squirted over a target region while suppressing the effect of an airflow to a minimum while a vehicle is traveling.

### BRIEF DESCRIPTION OF DRAWINGS

FIG. 1 is a plan view illustrating configuration of relevant portions of a wiper device according to an exemplary embodiment of the present invention;

FIG. 2 is a plan view illustrating a wiping target face of a vehicle applied with a wiper device according to an exemplary embodiment of the present invention, viewed from the vehicle front upper direction;

FIG. 3A is a cross-section of a wiper blade and a wiper arm according to the exemplary embodiment of the present invention in a schematic cross-section taken along line A-A in FIG. 1; and

FIG. 3B is a cross-section of the wiper blade and the wiper arm according to the exemplary embodiment of the present invention in a schematic cross-section taken along line B-B in FIG. 1.

### DESCRIPTION OF EMBODIMENTS

### Present Exemplary Embodiment Configuration

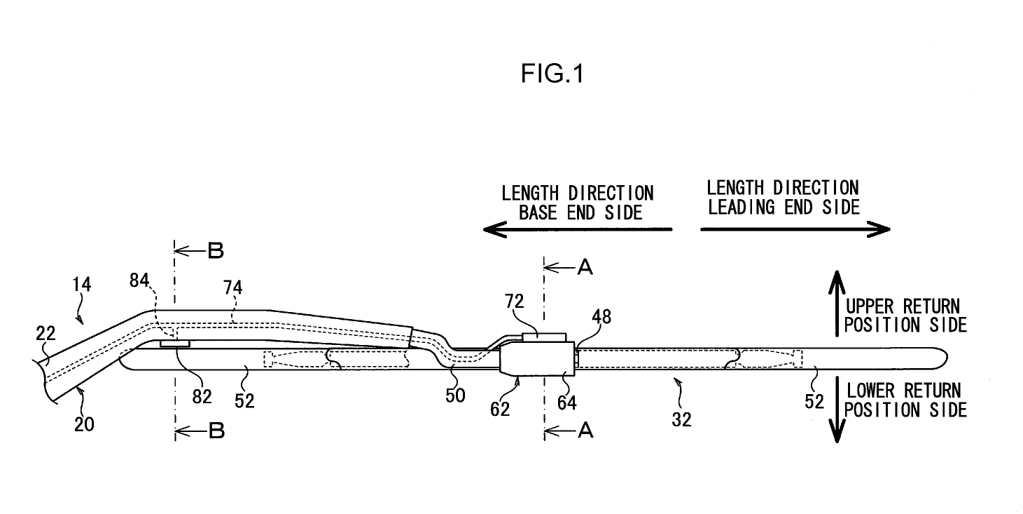

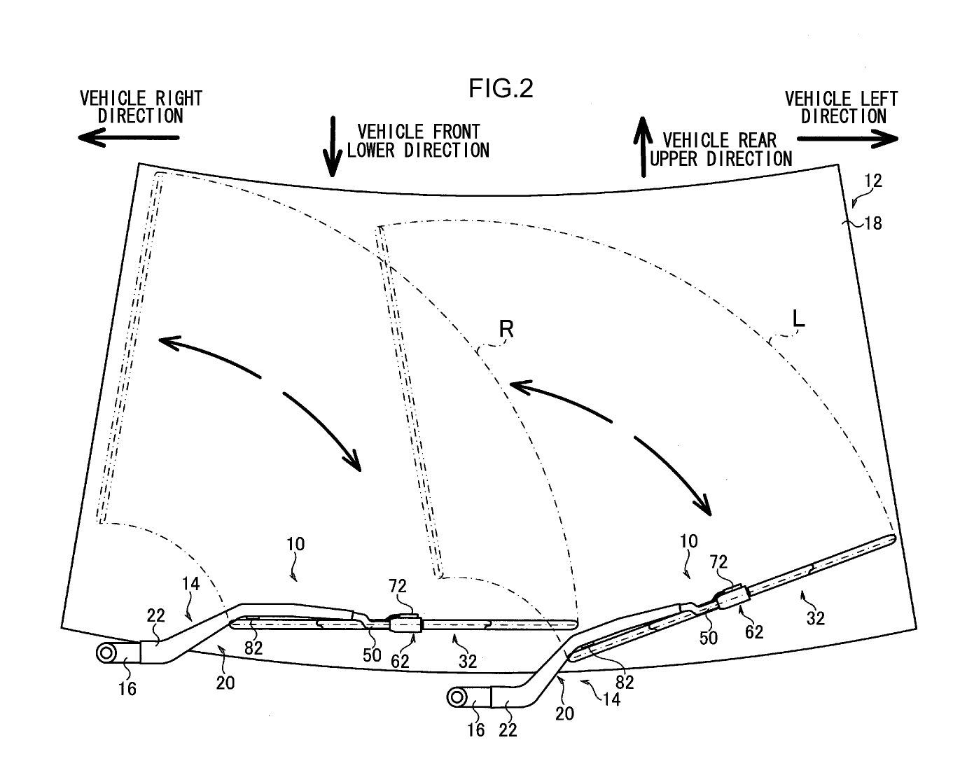

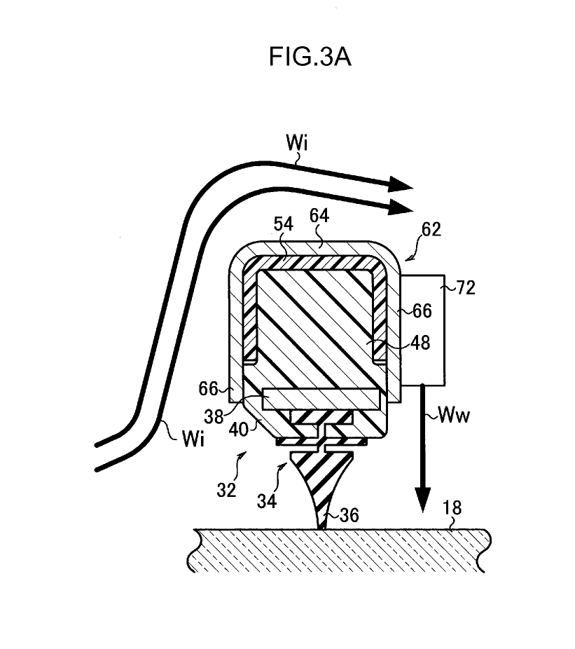

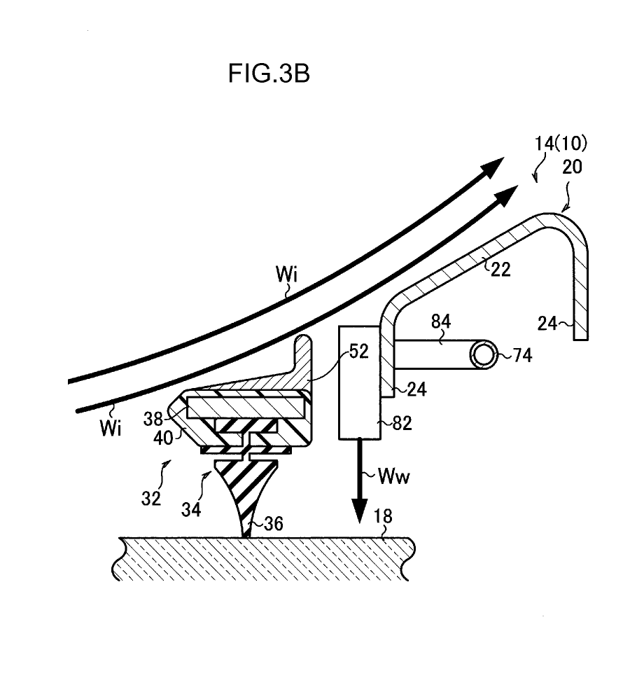

FIG. 1 is an enlarged plan view illustrating configuration of relevant portions of a vehicle wiper device 10 according to an exemplary embodiment of the present invention, and FIG. 2 is a plan view illustrating a vehicle 12 applied with the vehicle wiper device 10, viewed from the vehicle front upper direction. FIG. 3A is a schematic cross-section taken along line A-A in FIG. 1, and FIG. 3B is a schematic cross-section taken along line B-B in FIG. 1.

As illustrated in FIG. 1, the vehicle wiper device 10 includes a wiper arm 14. As illustrated in FIG. 2, the wiper arm 14 includes an arm head 16, a retainer 20, an arm piece 50, and a leading end coupling portion 62. An output shaft of a wiper motor, not illustrated in the drawings, is directly or indirectly coupled to a base end side of the arm head 16 at a location further to the vehicle front lower side than a windshield glass 18, which acts as a wiping target face of the vehicle 12. The arm head 16 is swung to-and-fro about the base end side of the arm head 16 due to the driving force of the wiper motor.

Note that a configuration may be applied in which the base end side of the arm head 16 is directly coupled to the output shaft of the wiper motor, and the arm head 16 is swung to-and-fro by forward drive and reverse drive of the wiper motor. Alternatively, for example, a configuration may be applied in which the base end side of the arm head 16 and the output shaft of the wiper motor are coupled by a link mechanism, and the arm head 16 is swung to-and-fro solely by forward driving force of the wiper motor. Although a pair of left and right vehicle wiper devices 10 are provided to the vehicle 12 illustrated in FIG. 2, the arm heads 16 of the vehicle wiper devices 10 may either be swung to-and-fro by a single wiper motor, or may each be swung to-and-fro by separate wiper motors.

A base end side of the retainer 20 is coupled to a leading end side of the arm head 16. As illustrated in FIG. 3B, the retainer 20 includes an upper wall 22 and a pair of side walls 24, extending from both width direction ends of the upper wall 22 toward a windshield glass 18 side. An overall cross-section profile of the retainer 20 cut away along the width direction thereof thereby forms a concave shape open toward the windshield glass 18 side. A leading end side of the thus configured retainer 20 extends over the windshield glass 18.

A base end side of the arm piece 50, this being a plate shaped bar member, is connected to the leading end side of the retainer 20, and the arm piece 50 extends to a length direction center portion of a wiper blade 32. The leading end coupling portion 62 is provided to a leading end side of the arm piece 50 so as to house a blade holder 48, described later. As illustrated in FIG. 3A, the leading end coupling portion 62 includes an upper wall 64 positioned above the blade holder 48 in an assembled state of the wiper blade 32, and a pair of side walls 66, formed extending from both width direction sides of the upper wall 64 toward the windshield glass 18. A width direction cross-section profile of the leading end coupling portion 62 forms a concave shape open toward the windshield glass 18 side.

As illustrated in FIG. 3A and FIG. 3B, the wiper blade 32 includes a rubber blade 34, a backing 38, and a retaining member 40. The rubber blade 34 is formed in an elongated shape with its length direction running along the length direction of the wiper blade 32 (see FIG. 1). A lip portion 36 with a taper shaped cross-section with a width dimension that gradually decreases on progression toward the windshield glass 18 side is formed to the rubber blade 34. A leading end of the lip portion 36 (the leading end at the windshield glass 18 side) contacts the windshield glass 18.

The backing 38, formed of a spring material, is disposed at an upper face side of a base portion of the rubber blade 34. The backing 38 is formed in a plate shape with its length direction running along the length direction of the wiper blade 32, and a length direction center portion of the backing 38 is formed curving in a convex shape toward the opposite direction to the windshield glass 18 in a natural state (an unloaded state). The retaining member 40 is formed of a resilient resin material and houses and retains the backing 38 and the rubber blade 34. The rubber blade 34 and the retaining member 40 are configured following the curve of the windshield glass 18 due to the spring force caused by the curve of the backing 38 described above.

As illustrated in FIG. 1, the blade holder 48 is coupled to the length direction center portion of the wiper blade 32. As illustrated in FIG. 3A, the blade holder 48 houses and retains length direction center portions of the backing 38 and the rubber blade 34, similarly to the retaining member 40. The blade holder 48 is configured in a block shape at an upper portion side of the backing 38, and is housed together with a clip 54 in the leading end coupling portion 62 provided at the leading end side of the wiper arm 14. The blade holder 48 is coupled to the leading end coupling portion 62 so as to be both turnable and detachable by using the clip 54.

As illustrated in FIG. 1, at a portion of the wiper arm 14 that is positioned alongside a portion of the wiper blade 32 at a base end portion side in the length direction thereof from the blade holder 48, specifically, at the portion of the wiper arm 14 between the leading end of the retainer 20 coupled to the arm piece 50 and an intermediate portion in the length direction of the retainer 20, the retainer 20 bends or curves as appropriate so as to be positioned at an upper return position side with respect to the wiper blade 32. The portion of the retainer 20 positioned further to the upper return position side than the wiper blade 32 inclines such that the upper wall 22 gradually separates from the windshield glass 18 on progression toward the upper return position side.

An airflow passage suppression portion 52 is provided at the retaining member 40 at the opposite side from the rubber blade 34, except for at a placement portion of the blade holder 48 to the retaining member 40. A face of the airflow passage suppression portion 52 at the opposite side from the retaining member 40 has, in the width direction of the wiper blade 32, an inclined shape that gradually separates from the surface of the windshield glass 18 on progression toward the upper return position side (in an upward gradient on progression toward the upper return position side) (see FIG. 1). As a result, an airflow Wi flowing over the windshield glass 18 from a width direction lower return position side of the wiper blade 32 (see FIG. 1) toward the wiper blade 32 is guided and steered by the airflow passage suppression portion 52, and flows upward so as to move further away from the windshield glass 18. The wiper blade 32 is pressed against the windshield glass 18 by the airflow Wi blown onto the wiper blade 32.

In particular, as illustrated in FIG. 3B, the airflow Wi is blown onto the wiper blade 32 prior to reaching the wiper arm 14 (specifically, the retainer 20) at the length direction base end side of the wiper blade 32 (see FIG. 1). The positional relationship of the wiper blade 32 and the retainer 20 is set such that airflow guided and steered by the airflow passage suppression portion 52, flows toward the top of the wiper arm 14, and reaches above the upper wall 22 that is inclined as described above. Namely, in the present exemplary embodiment, the airflow Wi passing above the wiper blade 32 is suppressed or prevented from passing between the wiper arm 14 (the retainer 20) and the windshield glass 18 by the airflow passage suppression portion 52 of the wiper blade 32.

The length direction center portion of the wiper blade 32 is coupled to the leading end coupling portion 62 provided at the leading end side of the wiper arm 14 (the arm piece 50). Of the pair of side walls 66 of the leading end coupling portion 62, a washer nozzle 72 is attached to the outside of the side wall 66 at the upper return position side. A leading end side of a washer fluid supply tube 74, routed along the wiper arm 14, is connected to the washer nozzle 72.

The washer fluid supply tube 74 passes from the washer nozzle 72 to between both side walls 24 of the retainer 20, and a base end portion of the washer fluid supply tube 74 is connected to a washer pump, not illustrated in the drawings, mounted to the vehicle 12, and also linked to a washer tank, not illustrated in the drawings, via the washer pump. A washer fluid Ww, acting as a cleaning fluid, stored in the washer tank is supplied to the washer fluid supply tube 74 on operation of the washer pump.

The washer fluid Ww passes through the inside of the washer fluid supply tube 74, is supplied to the washer nozzle 72, and ejected from the washer nozzle 72 toward the windshield glass 18. This enables the washer fluid Ww to be squirted from the length direction center portion of the wiper blade 32 toward the leading end side of the wiper blade 32 that is on the upper return position side, and onto the surface of the windshield glass 18.

A washer nozzle 82 is provided at the retainer 20 that is positioned alongside a portion of the wiper blade 32 that is located further to the base end portion side in the length direction thereof than the blade holder 48. In other words, of the pair of side walls 24 that are located further to the base end portion side of the retainer 20 than the leading end coupling portion 62, the washer nozzle 82 is attached to an outside face of the side wall 24, at the wiper blade 32 side.

A washer fluid supply tube 84 that pierces through the side wall 24 of the retainer 20 is linked to the washer nozzle 82. The washer fluid supply tube 84 branches from an intermediate portion of the washer fluid supply tube 74 through a joint or the like. A portion of the washer fluid Ww passing through the washer fluid supply tube 74 thereby flows into the washer fluid supply tube 84, and the washer fluid Ww can be squirted from the washer nozzle 82 further to the length direction base end side of the wiper blade 32 than the leading end coupling portion 62, onto the windshield glass 18. Moreover, the washer fluid Ww can be squirted on the upper return position side of the wiper blade 32 and on the lower return position side of the retainer 20.

The washer nozzle 82 is provided so as to oppose faces at an upper return position side of the retaining member 40 and the airflow passage suppression portion 52, and airflow Wi that has passed above the airflow passage suppression portion 52 passes the washer nozzle 82 on the opposite side to the windshield glass 18, namely, above the retainer 20.

### Operation and Advantageous Effects of Present Exemplary Embodiment Explanation Follows Regarding Operation and Advantageous Effects of the Present Exemplary Embodiment.

In the vehicle wiper device 10, on operation of the wiper motor and transmission of the drive force of the wiper motor to the wiper arm 14, the wiper blade 32 coupled to the leading end side of the wiper arm 14 swings to-and-fro about the base end side of the arm head 16. When the wiper blade 32 that has swung from the lower return position (the position of the wiper blade 32 illustrated by solid lines in FIG. 2) reaches the upper return position (the position of the wiper blade 32 illustrated by double-dotted dashed lines in FIG. 2), the arm head 16 reverses from this swing direction, and the wiper blade 32 swings toward the lower return position. A range R and a range L of the windshield glass 18, illustrated by single-dotted dashed lines, are wiped by the wiper blades 32 swinging to-and-fro in this way.

In cases in which, for example, the washer pump described above is operated while the wiper blade 32 swings from the lower return position toward the upper return position, washer fluid Ww stored inside the washer tank is supplied to the washer fluid supply tube 74. The washer fluid Ww supplied to the washer fluid supply tube 74 is supplied to the washer nozzle 72, and the washer fluid Ww is ejected from the washer nozzle 72 toward the windshield glass 18. The washer fluid Ww is thereby squirted from the length direction center portion of the wiper blade 32 toward the length direction leading end side and on the upper return position side of the wiper blade 32.

A portion of the washer fluid Ww supplied to the washer fluid supply tube 74 is supplied from the intermediate portion thereof to the washer fluid supply tube 84. Washer fluid Ww that has passed through the washer fluid supply tube 84 is supplied to the washer nozzle 82, and the washer fluid Ww is ejected from the washer nozzle 82 toward the windshield glass 18. The washer fluid Ww is thereby squirted onto the windshield glass 18 on the upper return position side and at the length direction base end side of the wiper blade 32.

Due to the rubber blade 34 of the wiper blade 32 wiping the surface of the windshield glass 18 in a state in which the washer fluid Ww is squirted onto the windshield glass 18, adhered matter that has adhered to the surface of the windshield glass 18 can be easily wiped off, while the wiper blade 32 swings smoothly over the surface of the windshield glass 18.

In a state in which the vehicle 12 is traveling, the airflow Wi flows over the surface of the windshield glass 18 from the front toward the rear of the vehicle 12. The retainer 20 is positioned further to the upper return position side than the wiper blade 32 at a portion where the washer nozzle 82, acting as a base end side nozzle of the wiper arm 14, is provided. Moreover, of the pair of side walls 24 of the retainer 20, the washer nozzle 82 is attached to the side wall 24 at the wiper blade 32 side. In other words, the washer nozzle 82 is attached to the side wall 24 at the lower return position side of the retainer 20, between the side wall 24 and the wiper blade 32.

In other words, the wiper blade 32 is positioned further to the lower return position side than the washer nozzle 82. The airflow Wi flowing over the surface of the windshield glass 18 from the vehicle front toward the rear when the vehicle 12 is traveling is therefore blocked by the wiper blade 32, and passes from an upper side of the wiper blade 32 to an upper side of the retainer 20. As a result, airflow between the retainer 20 and the windshield glass 18 can be prevented from crossing the trajectory of the washer fluid Ww ejected from the washer nozzle 82, acting as a base end side nozzle, toward the windshield glass 18, and the washer fluid Ww from the washer nozzle 82 is not liable to be affected by the airflow Wi.

Moreover, even when the airflow Wi is flowing along the length direction of the wiper blade 32 while the wiper blade 32 is at a partway position wiping toward the upper return position, since the washer nozzle 82 is provided further to the base end side of the wiper arm 14 than the leading end coupling portion 62, the washer fluid Ww can be sufficiently supplied toward the length direction base end side of the wiper blade 32 on the windshield glass 18 from an extremely close distance, while the effect of the airflow Wi can be kept to a minimum.

Moreover, the airflow passage suppression portion 52 is provided at the wiper blade 32 at least further to the base end side than the portion coupling to the wiper arm 14, namely the blade holder 48 (or the leading end coupling portion 62). The airflow Wi flowing over the surface of the windshield glass 18 while the vehicle 12 is traveling is effectively suppressed or restricted from passing between the washer nozzle 82 and the windshield glass 18 due to the airflow passage suppression portion 52.

Furthermore, since the airflow passage suppression portion 52 is provided at the upper portion of the wiper blade 32 (the upper portion of the retaining member 40), the airflow Wi blown onto the wiper blade 32 is guided above the washer nozzle 82 at the opposite side to the windshield glass 18.

Guiding the airflow Wi in this manner not only enables passage of the airflow Wi between the washer nozzle 82 and the windshield glass 18 to be prevented or reduced, but also presses the wiper blade 32 against the windshield glass 18. This also enables the wiper blade 32 to be prevented from lifting up off the windshield glass 18.

The retainer 20 inclines such that the upper wall 22 gradually separates from the windshield glass 18 on progression toward the upper return position side. The airflow Wi, which has been guided to the opposite side to the windshield glass 18 by the airflow passage suppression portion 52, passes the opposite side to the windshield glass 18 of the washer nozzle 82, is steered to the upper wall 22 of the retainer 20, and flows toward the rear of the vehicle 12 while moving away from the windshield glass 18.

The washer nozzle 82 acts as a base end side nozzle supplying washer fluid Ww further to the base end side of the wiper blade 32 than the leading end coupling portion 62, and the washer nozzle 72 acts as a leading end side nozzle provided further to the leading end side of the wiper arm 14 than the washer nozzle 82 that is the base end side nozzle. The washer fluid Ww from the washer nozzle 72 is supplied further to the length direction leading end side than the leading end coupling portion 62 and on the upper return position side of the wiper blade 32.

In cases in which the surface of the windshield glass 18 is wiped by a long wiper blade, when washer fluid Ww is supplied from the washer nozzle 82, the airflow Wi can be used to supply the washer fluid Ww to some extent toward the leading end portion of the wiper blade at a wiping partway position; however spreading the washer fluid Ww across to the leading end portion takes time. However, since the washer nozzle 72 is provided as a leading end side nozzle further to the leading end side of the wiper arm 14 than the washer nozzle 82, a sufficient amount of liquid can be quickly spread across to the leading end portion, even in cases in which a long wiper blade is used.

The retainer 20 and the leading end coupling portion 62 of the wiper arm 14 include the respective pairs of side walls 24, 66. Of the pair of side walls 24 of the retainer 20, the washer nozzle 82 is attached to the side wall 24 at the wiper blade 32 side. Of the pair of side walls 66 of the leading end coupling portion 62, the washer nozzle 72 is attached to the side wall 66 at the opposite side to the wiper blade 32 side.

A portion of the retainer 20, which locates further to the base end side than the position of the wiper arm 14 coupling to the wiper blade 32, is disposed alongside the wiper blade 32, such that supply of the washer fluid Ww to the base end side of the wiper blade 32 is mainly performed through the washer nozzle 82 provided at the retainer 20. Of the pair of side walls 24 of the retainer 20, it is preferable that the washer nozzle 82 is disposed at the side wall 24 at the wiper blade 32 side, to enable unimpeded supply toward the wiper blade 32 at contact locations between the rubber blade 34 and the windshield glass 18, while also being less liable to be affected by airflow.

The washer fluid Ww is supplied to the leading end side of the wiper blade 32 by the washer nozzle 72 provided at the leading end coupling portion 62 of the wiper arm 14. The washer fluid Ww is ejected toward the length direction leading end side of the wiper blade 32. Of the pair of side walls 66 of the leading end coupling portion 62, the washer nozzle 72 is provided at the side wall 66 at the opposite side to the wiper blade 32 side such that ejection toward the length direction leading end side of the wiper blade 32 is enabled without crossing the wiper arm 14.

Note that although in the present exemplary embodiment the airflow passage suppression portion 52 and the retaining member 40 are configured as a single unit, the airflow passage suppression portion may be configured as a separate member, and the airflow Wi thereby restricted or suppressed from passing between the windshield glass 18 and the washer nozzle 82.

In the present exemplary embodiment, no means is provided in order to squirt the washer fluid Ww onto the windshield glass 18 at the lower return position side of the wiper blade 32. However, a configuration may be applied in which, for example, a separate washer nozzle is provided to the side wall 66 at the lower return position side of the leading end coupling portion 62, and this washer nozzle may branch from washer fluid supply tube 74, or be linked to a washer fluid supply tube of a separate system to the washer fluid supply tube 74. The washer fluid Ww may accordingly be squirted onto the windshield glass 18 at the lower return position side of the leading end coupling portion 62.

The entire contents of the disclosure of Japanese Patent Application No. 2012-231132 are incorporated by reference in the present specification. All publications, patent applications and technical standards mentioned in the present specification are incorporated by reference in the present specification to the same extent as if the individual publication, patent application, or technical standard was specifically and individually indicated to be incorporated by reference.

1. A vehicle wiper device comprising:
a wiper blade that wipes a specific range between a lower return position and an upper return position on a wiping target face, by swinging to-and-fro between the lower return position and the upper return position on the wiping target face;
a wiper arm that has a leading end side coupled to a center portion in a length direction of the wiper blade, and that swings to-and-fro about a base end side of the wiper arm to cause the wiper blade to swing to-and-fro between the lower return position and the upper return position, wherein at least a portion of the wiper arm that locates further to the base end side than a portion of the wiper arm coupled to the wiper blade is disposed at an upper return position side with respect to the wiper blade; and
a first washer nozzle that is provided at the portion of the wiper arm disposed further to the upper return position side than the wiper blade, and that squirts a cleaning fluid toward the upper return position side of the wiper blade,
wherein the wiper arm comprises a pair of side walls, and the first washer nozzle is disposed at the side wall at the wiper blade side from out of the pair of side walls.

2. The vehicle wiper device of claim 1, further comprising:
an airflow passage suppression portion that is provided at at least a portion of the wiper blade, the portion of the wiper blade locates further to a base end side than a coupling portion of the wiper blade to the wiper arm, and that suppresses or restricts an airflow from passing between the first washer nozzle and the wiping target face while the vehicle is travelling.

3. The vehicle wiper device of claim 2, wherein the airflow passage suppression portion is provided at an upper portion of the wiper blade, and the airflow passage suppression portion is configured to guide the airflow to the opposite side to the wiping target face with respect to the first washer nozzle and to press the wiper blade against the wiping target face.

4. The vehicle wiper device of claim 1, wherein:
the first washer nozzle acts as a base end side nozzle supplying the cleaning fluid further to the base end side than the coupling portion of the wiper blade; and
a second washer nozzle is provided further to the leading end side of the wiper arm than the first washer nozzle, with the second washer nozzle acting as a leading end side nozzle supplying the cleaning fluid on the upper return position side of the wiper blade and at further to the leading end side than the coupling portion of the wiper blade.

5. The vehicle wiper device of claim 4, wherein the second washer nozzle is disposed at the side wall at the opposite side to the wiper blade side from out of the pair of side walls.

6. The vehicle wiper device of claim 2, wherein a face of the airflow passage suppression portion, at the opposite side from the wiper blade, forms an inclined face with increasing a thickness in cross-section of the airflow passage suppression portion on progression from the lower return position side toward the upper return position side.

7. The vehicle wiper device of claim 1, wherein the first washer nozzle is disposed at an outside face of the side wall at the wiper blade side from out of the pair of side walls.

8. The vehicle wiper device of claim 1, wherein the first washer nozzle is configured so as to eject the cleaning fluid onto a windshield glass, at the upper return position side and toward a length direction base end portion of the wiper blade, and between the wiper arm and the wiper blade.
